(19) United States
(12) Patent Application Publication
(10) Pub. No.: US 2019/0079571 A1
(43) Pub. Date: Mar. 14, 2019

(54) POWER CONTROL SYSTEMS AND METHODS FOR INTEGRATING AUXILIARY POWER SYSTEMS

(71) Applicant: Outback Power Technologies, Inc., Arlington, WA (US)

(72) Inventors: Brian James Faley, Mount Vernon, WA (US); Nathan Peder Foss, Camano Island, WA (US)

(21) Appl. No.: 16/125,464

(22) Filed: Sep. 7, 2018

Related U.S. Application Data
(60) Provisional application No. 62/556,272, filed on Sep. 8, 2017.

(51) Int. Cl. G06F 1/3206; H02M 3/02; H02J 3/38

(52) U.S. Cl. CPC G06F 1/3206; H02J 3/381; H02M 3/02

(57) ABSTRACT

The present invention may be embodied as a power supply system for supplying power to a load from a grid power source and at least one auxiliary power source. The power supply system comprises at least one power control system comprising a power integration system, a power management board, a device controller, and a communications sub-system. The communications sub-system configured with at least one wiring assembly operatively connected to the device controller and configured to carry a first set of data and at least one wiring assembly operatively connected to the device controller and configured to carry a second set of data. The device controller operates the power management board at least in part based on the first set of data. The device controller operates the power integration system at least in part based on the second set of data.

### TECHNICAL FIELD

The present invention relates to systems and methods for the integration of auxiliary energy production systems, and more particularly, to an auxiliary power integration system for integrating auxiliary power sources to a power grid and/or to a load.

### BACKGROUND

Wind-powered turbine and photovoltaic (PV) array auxiliary power generation technologies are available at the consumer level. Power supply systems employing auxiliary power generation systems may further include power storage systems, such as batteries, to store energy for when wind and solar power is not available. Auxiliary power generation and storage systems are often non-standardized. As such, consumers are left without a simple, cost effective means for integrating consumer owned and operated power generation systems, consumer owned and operated energy storage systems, and/or the utility power grid. Accordingly, the need exists for power supply systems and methods that facilitate the integration of auxiliary power systems, such as renewable energy generation technologies and energy storage technologies, with the utility power grid to supply power to a load.

### SUMMARY

The present invention may be embodied as a power supply system for supplying power to a load from a grid power source and at least one auxiliary power source. The power supply system comprises at least one power control system comprising a power integration system, a power management board, a device controller, and a communications sub-system. The power integration system is operatively connected between the at least one auxiliary power source and the load. The power management board is configured to selectively connect the grid power source to the power integration system. The device controller is operatively connected to the power integration system and to the power management board. The communications sub-system is configured with at least one wiring assembly operatively connected to the device controller and configured to carry a first set of data and at least one wiring assembly operatively connected to the device controller and configured to carry a second set of data. The device controller operates the power management board at least in part based on the first set of data. The device controller operates the power integration system at least in part based on the second set of data.

The present invention may also be embodied as a power supply system for supplying power to a load from at least one of a grid power source and a plurality of auxiliary power sources comprising first and second power control systems. The first power control system comprises a first power integration system, a first power management board, a first device controller, and a first communications sub-system. The first power integration system is operatively connected between at least one of the plurality of auxiliary power sources and the load. The first power management board is configured to selectively connect the grid power source to the first power integration system. The first device controller is operatively connected to the first power integration system and to the first power management board. The first communications sub-system is configured to carry a first set of data to the first power management board and a second set of data to the first device controller. The second power control system comprises a second power integration system, a second power management board, a second device controller, and a second communications sub-system. The second power integration system is operatively connected between at least one of the plurality of auxiliary power sources and the load. The second power management board is configured to selectively connect the grid power source to the second power integration system. The second device controller is operatively connected to the second power integration system and to the second power management board. The second communications sub-system is configured to carry the first set of data to the second power management board and the second set of data to the second device controller. The first device controller operates the first power management board at least in part based on the first set of data. The first device controller operates the first power integration system at least in part based on the second set of data. The second device controller operates the second power management board at least in part based on the first set of data. The second device controller operates the second power integration system at least in part based on the second set of data.

The present invention may also be embodied as a method of supplying power to a load from a grid power source and a plurality of auxiliary power sources comprising the following steps. A plurality of power control systems is provided. Each of the plurality of power control systems comprises a power integration system, a power management board, a device controller, and a communications sub-system. Each power integration system is operatively connected between at least one of the plurality of auxiliary power sources and the load. Each power management board is configured to selectively connect the grid power source to the power integration system. Each device controller is operatively connected to the power integration system and to the power management board. Each communications sub-system is configured to carry data to the power management board and the device controller. One of the power control systems is identified as a master power control system. The master power control system is caused to transmit a first set of data to the power management boards. The master power control system is caused to transmit a second set of data to the power integration systems.

### BRIEF DESCRIPTION OF THE DRAWINGS

FIG. 1 is a block diagram of an example power supply system configured to integrate one or more auxiliary power sources with the grid and a load;

FIG. 2 is a combination block/circuit diagram illustrating a first example power control system that may be used by the example power supply system;

FIG. 3 is a block diagram of a first example power integration system that may be used as part of the first example power control system, the first example power integration system being shown in a first example configuration; and

FIG. 4 is a logic flow diagram illustrating an example logic flow implemented by a first example local controller of the first example power control system.

### DETAILED DESCRIPTION

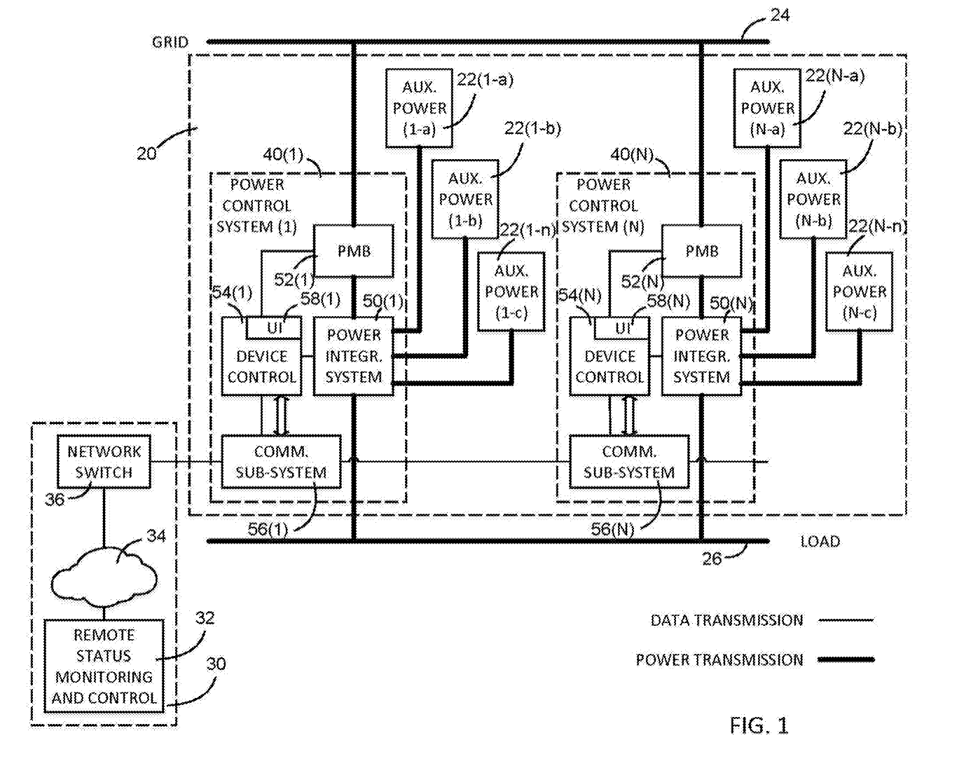

Referring initially to FIG. 1 of the drawing, depicted therein is an example power supply system 20 constructed in accordance with, and embodying, the principles of the present invention. The example power supply system 20 is operatively connected to at least one auxiliary power system 22, a utility power grid 24, and a load 26. The example power supply system 20 is further operatively connected to a communications system 30 comprising a remote status monitoring and control system 32, a communications system 34, and a network switch 36. The auxiliary power systems 22, grid 24, load 26, remote status monitoring and control system 32, communications system 34, and network switch 36 are not necessarily part of the present invention and will be described herein only to that extent necessary for a complete understanding of the present invention.

The example power supply system 20 comprises at least one power control system 40, and each power control system 40 is operatively connected to at least one of the auxiliary power systems 22. A power supply system of the present invention may have as few as a single power control system 40 or, theoretically, an unlimited number of the power control systems 40. The number of power control systems 40 is generally related to the number and type of auxiliary power systems 22 supported by the example power supply system 20.

FIG. 1 further illustrates that each of the example power control system(s) 40 comprises a power integration system 50, a power management board 52, a device control system 54, and a communications sub-system 56. In addition, each of the device control systems 54 comprises user interface hardware 58.

Each power integration system 50 is configured to operate in at least one operating mode. In each operating mode, at least one input power signal is input to the power integration system 50. For any given power integration system 50, the input power signal may be a utility power signal from the grid 24 or an auxiliary power signal from the auxiliary power system 22 associated with the given power integration system 50. Further, each power integration system 50 generates an output power signal based on one or more input power signals. The output power signal may be applied to the grid 24, to the load 26, and/or to an energy storage device forming the auxiliary power system 22 associated with that given power integration system 50.

In a power supply system 20 comprising a single auxiliary power system 22 and a single power control system 40 that is not connected to the remote status monitoring and control system 32, the operating mode of the power integration system 50 may be controlled completely within the power control system 40 using the power integration system 50, the power management board 52, and the device control system 54. Accordingly, when a single power control system 40 is present, that power control system 40 is capable of operating in a stand-alone manner. In this context, the device control system 54 determines parameters that are used by the power control system 40 operating in the stand-alone mode.

In a power supply system 20 comprising multiple auxiliary power systems 22 and multiple power control systems 40, the mode in which the plurality (two or more) power integration systems 50 operate is coordinated among the plurality of power control systems 40 using the power management boards 52, the device control systems 54, and the communications sub-systems 56 of the plurality of power control system 50. When multiple power control systems 40 are present as shown in the example power supply system 20, the operation of those power control systems 40 is coordinated using the communications sub-systems 56. In this scenario, one of the power control systems 40 may be identified as a master power control system, and the remaining power control systems 40 are identified as slave power control systems. The master power control system 40, and in the example power control system 40 the device control system 54, will control at least some functions of the slave power control systems 40.

The example communications sub-system 56 allows communication among the master and slave power control systems 40 and, optionally, between any given power control systems 40 and the local status monitoring and control system 28 and/or the remote status monitoring and control system 32. The example communications sub-system 56 is configured to communicate status monitoring and control data with the power integration system 50 and device control data with the device control system 54. The status monitoring and control data is used to perform routine, non-time critical functions such as determining status of the power integration system 50 and any auxiliary power system 22 associated therewith. The device control data is used to perform time critical functions such as coordinating operating mode changes among the plurality of power control systems 40.

The example power supply system 20 thus facilitates the integration of auxiliary power sources 22 to define a power system configuration appropriate for the particular configuration of hardware forming the example power supply system 20. Further, the exact nature of the hardware selected to form the example power supply system 20 need not be known in advance.

The example power supply system 20 depicted in FIG. 1 may comprise one or more of the power control systems 40, and suffixes “1” and “n” are used in FIG. 1 in connection with the reference characters “40”, “50”, “52”, “54”, “56”, and “58” to identify individual examples of the same type of element. Further, each of the power control system 40 may be connected to one or more of the auxiliary power sources 22, and the suffixes (1-a), (1-b), (1-n), (N-a), (N-b), and (N-n) are used in FIG. 1 to represent the auxiliary power supplies 22 depicted therein. The limitation on the number of power control systems 40 and auxiliary power sources 22 associated with each power control system 40 is, theoretically, unlimited, but practical considerations may effective limit either of these elements 40 or 22 to a predetermined number greater than 1.

With the foregoing general understanding of the present invention in mind, the details of examples of the power control system 40 and the power integration system 50 forming a part thereof will now be described in further detail.

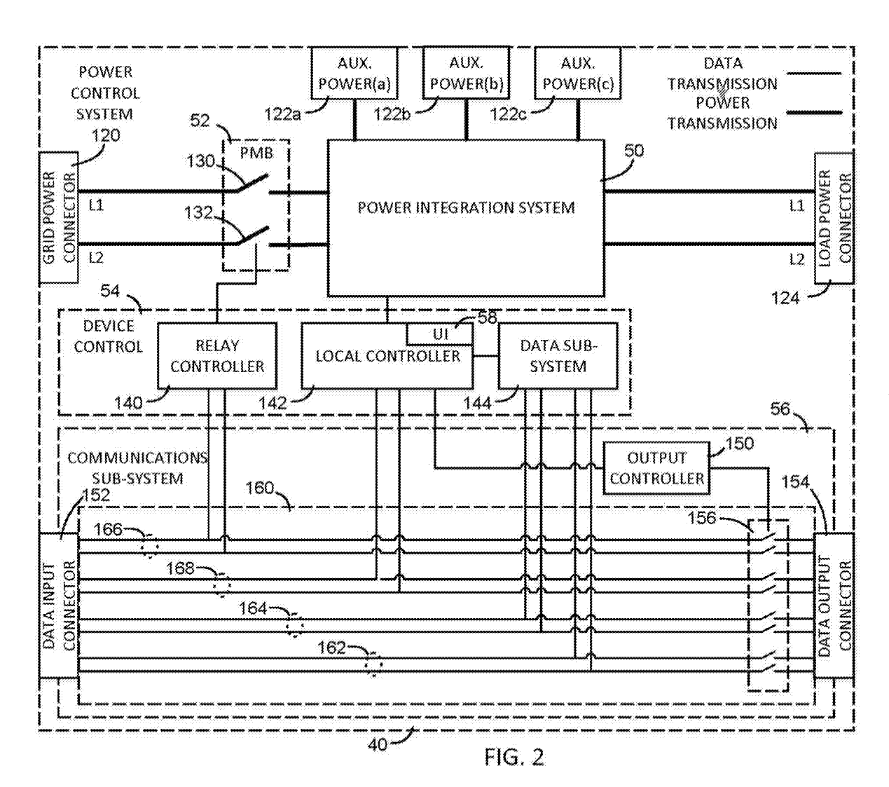

Turning now to FIG. 2 of the drawing, depicted therein are the details of an example power control system 40 that may be used as part of a power supply system of the present invention. The example power integration system 50 of the example power control system 40 defines a grid power connector 120, three auxiliary power connectors 122a, 122b, and 122c, and a load power connector 124. The example power control system 40 depicted in FIG. 2 is thus capable of accommodating up to three of the auxiliary power sources 122.

The example power management board 52 of the example power control system 40 comprises first and second relays 130 and 132. The example device control system 54 of the example power control system 40 comprises a relay controller 140, a local controller 142, and a data sub-system 144. The example local controller 142 is operatively connected to or incorporates the user interface hardware 58 of the example device control system 54. The example communications sub-system 56 of the example power control system 40 comprises an output controller 150, a data input connector 152, and a data output connector 154.

As also shown in FIG. 2, the example communications sub-system 56 further comprises a cable assembly 160 that extends between the data input connector 152 and the data output connector 154. The example cable assembly 160 comprises a first conductor pair 162, a second conductor pair 164, a third conductor pair 166, and a fourth conductor pair 168. The first and second conductor pairs 162 and 164 are connected to the data sub-system 144 of the device control system 54. In the example communications sub-system 56, the first and second conductor pairs 162 and 164 form transmit and receive cables of an ethernet based communications system, but other standard or non-standard communications systems may be used in addition to or instead of an ethernet based communications system. The third conductor pair 166 is further operatively connected to the relay controller 140. The fourth conductor pair 168 is further operatively connected directly to the local controller 142.

The communications system implemented using the first and second data pairs 162 and 164 is capable of transmitting status monitoring and control information, and in particular is capable of data associated with non-time critical functions carried out by the power control system 40. The third and fourth conductor pairs 166 and 168 carry device control data used for time critical functions carried out by the power control system 40. The first and second data pairs 162 and 164 thus allow time critical functions to be coordinated and implemented in near real time.

The output controller 150 controls the output switch array 156 to connect the data output connector 154 to or disconnect the data output connector 154 from the data sub-system 144, the relay controller 140, the local controller 142, and the data input connector 152. In particular, when the local controller 142 determines that the output data connector 154 of a given power control system 40 is connected to the input data connector 152 of another of plurality of power control systems 40, the output switch array 156 is configured to be in a closed configuration. When a given power control system 40 is the only power control system 40 of the power supply system 20 or is the last power control system 40 of a plurality of power control systems 40, the output controller 150 is controlled to open the switches forming the switch array 156 to disconnect the data output connector 154 from the data sub-system 144, the relay controller 140, the local controller 142, and the data input connector 152. When the output data connector 154 of a given power control system 40 is connected to the input data connector 152 of another of a plurality of power control systems 40 forming the power supply system 20, data may be carried between any of the plurality of control systems 40.

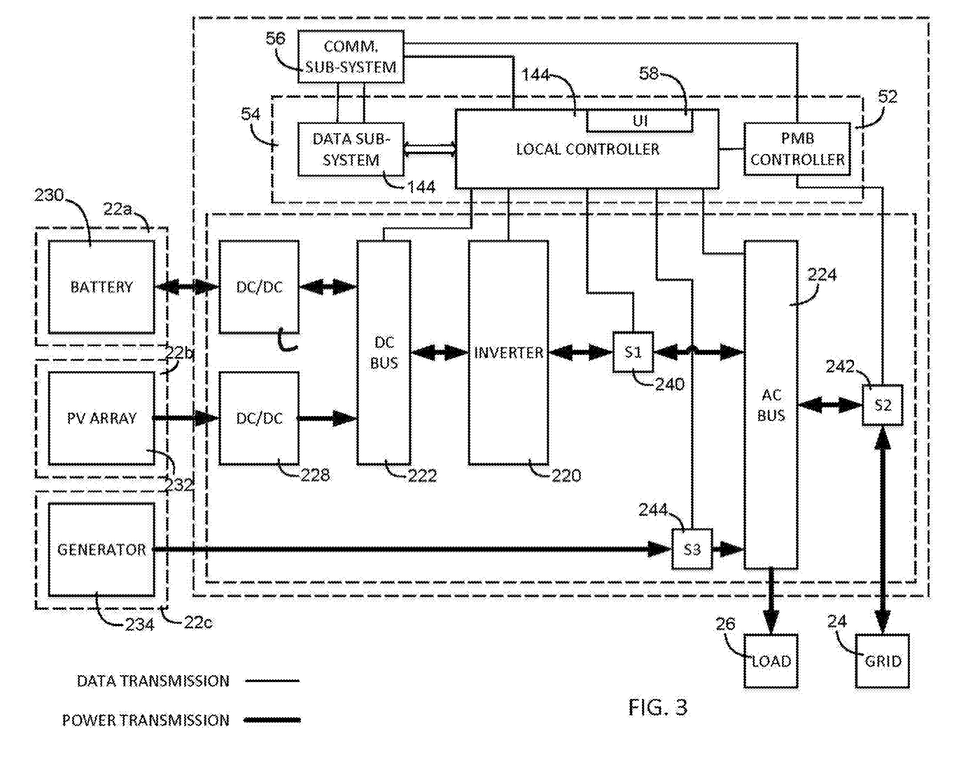

Turning now to FIG. 3 of the drawing, an example power integration system 50 that may be used by the example power control system 40 will now be described in further detail. The example power integration system 50 depicted in FIG. 3 comprises an inverter 220, a DC bus 222, an AC bus 224, a first DC/DC converter 226, and a second DC/DC converter 228. The example power integration system 50 depicted in FIG. 3 forms a part of an example power control system 40 that supports first and second DC auxiliary power sources 22a and 22b and an AC auxiliary power source 22c. The example first DC auxiliary power source 22a is formed by a battery 230, the example second DC auxiliary power source 22b is formed by a photovoltaic array 232, and the example AC auxiliary power source 22c is formed by a generator 234.

The inverter 220 is operatively connected between the DC bus 222 and the AC bus 224. The first DC/DC converter 226 is operatively connected between the battery 230 and the DC bus 222. The second DC/DC converter 228 is operatively connected between the PV array 232 and the DC bus 222.

The example power integration system 50 additionally comprises a first mode control switch 240, a second mode control switch 242, and a third mode control switch 244. The first mode control switch 240 is connected between the inverter 222 and the AC bus 224. The relays forming a part of the power management board 52 form the second mode control switch 242. The third mode control switch 244 is connected between the generator 234 and the AC bus 224.

The local controller 142 of the example power supply system 40 depicted in FIG. 3 is operatively connected to the inverter 220, the DC bus 222, and the AC bus 224 to sense a status of the inverter 220 and voltages on the buses 222 and 224. The example local controller 142 is further arranged to control operation of the inverter 220 and mode control switches 240, 242, and 244 to control the operating mode of the power supply system 40 and power integration system 50 forming a part thereof.

The example integration system 50 may be configured to handle up to three of the auxiliary power sources 22a, 22b, and 22c as shown in FIG. 3. However, the integration system 50 may integrate any one or any combination of two of the auxiliary power sources 22a, 22b, and 22c.

In any configuration, the local controller 142 is capable of sensing a DC voltage on the DC bus 222 and an AC voltage on the AC bus 224. Voltage data representing these DC and AC voltages can be stored and used for control of the example integration system 50. This voltage data, along with data representing other status information such as the state of the power management switches 130 and 132 and the first, second, and third mode control switches 240, 242, and 244, can also be stored by the local controller 142 as status data. Such status data can be later downloaded from the local controller and/or transmitted to the local status monitoring and control system 28 and/or the remote status monitoring control system 32 if the example power supply system 20 is connected to the communications system 30 as depicted in FIG. 1.

The example local controller 142 may be configured such that the local controller 142 controls the PMB controller 140, the inverter 220, and the mode control switches 240, 242, and 240 such that the integration system 50 changes operating modes in a timely and coordinated fashion within the context of the overall power supply system 20.

Additionally, if the local controller 142 of the master power control system 40 determines that the utility power signal on the AC bus 224 thereof is outside of predetermined parameters, the local controller 142 of that master power control system 40 directs the PMB controllers 140 and local controllers 142 of any slave power control systems 40 to direct the local controllers 142 of those slave power control systems 40 to switch to an operating mode in which the AC power signal is generated by one or more of the auxiliary power systems 22. This switch over may be accomplished by, for example, communicating zero-crossing information such that the change from utility mode to standby mode is coordinated among the various power control systems 40. The local controller 142 of the master power control system 40 of any given power supply system 20 thus is capable of communicating relatively directly and in near real time through the dedicated third and fourth conductor pairs 166 and 168 rather than using the data sub-system 144. Accordingly, operation of the example power supply system 20 is not adversely affected by any delays introduced by the communications system used to implement that data sub-system 144.

The example user interface hardware 58 may be any appropriate hardware, such as a touch screen, display screen, keyboard, mouse, or the like, for communicating information to and receiving information from a user. In this context, the local status monitoring and control system 28 will further define or define a user interface system that allows users with physical access to the example power supply system 20 to control (e.g., configure) and/or monitor the status of the power supply system 20 and any power control systems 40 forming a part thereof, any auxiliary power systems 22 connected thereto, and any grid 24 and/or load 26 to which the power supply system 20 is connected.

The remote status monitoring and control system 32 may be used to facilitate configuration of the example power supply system 20 and of the power control systems 40 forming a part thereof from a remote location and/or from a portable device that is not physically connected to the example power supply system 20 such as a smart phone or tablet. The remote status monitoring and control system 32 will typically comprise or be connected to a user interface device (not shown) such as a touch screen, display screen, keyboard, mouse, or the like. In this context, the remote status monitoring and control system 32 will further define or define a user interface system that allows users without physical access to the example power supply system 20 to control (e.g., configure) and/or monitor the status of the power supply system 20 and any power control systems 40 forming a part thereof, any auxiliary power systems 22 connected thereto, and any grid 24 and/or load 26 to which the power supply system 20 is connected. The remote status monitoring and control system 32 may provide the same, greater, or lesser functionality to the user than the local status monitoring and control system 28 depending on factors such as user identity, safety, privacy, and security.

The operating modes of any individual power integration system 50, any individual power control system 40, or the power supply system 20 in its entirety will depend on factors such as the specifics of the hardware forming a given power supply system 20 and/or parameters determined by the local status monitoring and control system 28 and/or remote status monitoring and control system 32. For example, the status monitoring and control systems 28 or 32 may be configured to alter the operating mode of any one or more power control systems 40 forming the power control system 20 based on the market price of electrical power at a particular point in time. For example, the power supply system 20 may be configured to sell power, including stored power, back to the electrical power utility when the spot price is high and to purchase power from the electrical power utility when the spot price is low. As another example, when the spot price of electrical power is high, the power supply system 20 may be configured to use generated and/or stored power rather than purchase electrical power so long as possible. As yet another example, the power supply system 20 may be configured to store power when the spot price is low and sell the stored power to the utility only after the spot price increases.

A power supply system 20 of the present invention can easily be configured to switch among any such modes as allowed by the specific hardware configuration defined by a particular implementation of that particular power supply system 20.

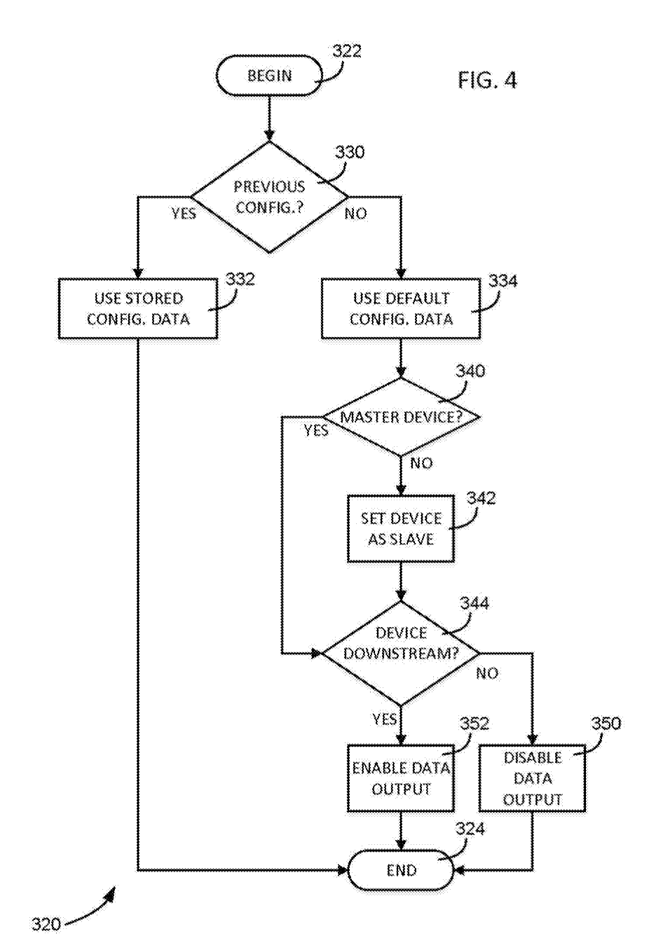

Turning now for a minute to FIG. 4 of the drawing, depicted therein is a logic diagram representing one example method 320 of operating the output controller 150 to control the output switch array 156 as generally described above. The example method 320 begins at a step 322 and ends at a step 324. At a step 330, the method 320 determines if a configuration of the output controller 150 has been previously stored. If so, that previous configuration is used at step 332, and the method 320 continues to the end step 324. If no configuration of the output controller 150 has been previously stored, the method 320 sets the output controller configuration according to a default configuration at step 334.

At a step 340, the method 320 determines whether the output controller 150 belongs to a master power control system 40. The output controller 150 belongs to a master power control system 40 if there is no other power control system 40 or if another power control system 40 has not already been assigned as the master power control system 40. If the output controller 40 does not belong to a master power control system 40, the method 320 sets the output controller 150 as belonging to a slave power control system 40 at step 342 and proceeds to step 344. If the output controller 40 belongs to the master power control system 40, the method 320 moves directly to step 344.

At step 344, the method 320 determines whether the output controller 150 of another power control system 40 is connected downstream of the control system 40 incorporating the given output controller. If the output controller 150 is part of the last power control system 40 of a chain formed by a plurality of power control systems 40, transmission of output data is disabled at step 350, and the method 320 moves to the end step 324. If the output controller 150 is not part of the last power control system 40 of a chain formed by a plurality of power control systems 40 (i.e., a downstream power control system 40 is connected), transmission of output data is enabled at step 352, and the method 320 moves to the end step 324.

What is claimed is:

1. A power supply system for supplying power to a load from a grid power source and at least one auxiliary power source, comprising:
at least one power control system comprising
a power integration system operatively connected between the at least one auxiliary power source and the load,
a power management board configured to selectively connect the grid power source to the power integration system,
a device controller operatively connected to the power integration system and to the power management board, and
a communications sub-system configured with
at least one wiring assembly operatively connected to the device controller and configured to carry a first set of data, and
at least one wiring assembly operatively connected to the device controller and configured to carry a second set of data; wherein
the device controller operates the power management board at least in part based on the first set of data; and
the device controller operates the power integration system at least in part based on the second set of data.

2. A power supply system as recited in claim 1, in which:
the first set of data is time critical; and
the second set of data is non time critical.

3. A power supply system as recited in claim 1, in which the device controller comprises:
a relay controller operatively connected to control the power management board based at least in part on the first set of data; and
a local controller operatively connected to control the power integration system based at least in part on the second set of data.

4. A power supply system as recited in claim 3, in which the device controller further comprises a data sub-system operatively connected to the local controller, where the data-sub-system allows the local controller to transmit data through the communications sub-system.

5. A power supply system as recited in claim 1, in which the power integration system is operatively connected between each of a plurality of auxiliary power sources and the load.

6. A power supply system as recited in claim 1, in which:
the at least one auxiliary power source is a direct current power source that generates a DC power signal; and
the power integration system comprises an inverter for converting the DC power signal from the direct current power source to an AC power signal.

7. A power supply system as recited in claim 5, in which:
at least one of the plurality of auxiliary power sources is a direct current power source that generates a DC power signal; and
the power integration system comprises an inverter for converting the DC power signal from the direct current power source to an AC power signal.

8. A power supply system as recited in claim 7, in which the power integration system further comprises:
a DC bus;
an AC bus operatively connected to the load; and
a DC/DC converter connected between the direct current power source and the DC bus; wherein
the inverter is operatively connected between the DC bus and the AC bus; and
the power management board is operatively connected between the grid power source and the AC bus.

9. A power supply system as recited in claim 5, in which at least one of the plurality of auxiliary power sources is an alternating current power source, where the alternating current power source is operatively connected to the AC bus.

10. A power supply system for supplying power to a load from at least one of a grid power source and a plurality of auxiliary power sources, comprising:
a first power control system comprising
a first power integration system operatively connected between at least one of the plurality of auxiliary power sources and the load,
a first power management board configured to selectively connect the grid power source to the first power integration system,
a first device controller operatively connected to the first power integration system and to the first power management board, and
a first communications sub-system configured to carry
a first set of data to the first power management board, and
a second set of data to the first device controller;
a second power control system comprising
a second power integration system operatively connected between at least one of the plurality of auxiliary power sources and the load,
a second power management board configured to selectively connect the grid power source to the second power integration system,
a second device controller operatively connected to the second power integration system and to the second power management board, and
a second communications sub-system configured to carry
the first set of data to the second power management board, and
the second set of data to the second device controller; wherein
the first device controller operates the first power management board at least in part based on the first set of data;
the first device controller operates the first power integration system at least in part based on the second set of data;
the second device controller operates the second power management board at least in part based on the first set of data; and
the second device controller operates the second power integration system at least in part based on the second set of data.

11. A power supply system as recited in claim 10, in which:
the first set of data is time critical; and
the second set of data is non time critical.

12. A power supply system as recited in claim 10, in which each of the first and second device controllers comprises:
a relay controller that operates at least in part on the first set of data; and
a local controller that operates at least in part on the second set of data.

13. A power supply system as recited in claim 12, in which the first and second device controllers each further comprises a data sub-system configured to allow the first and second local controller to transmit data through the communications sub-system.

14. A power supply system as recited in claim 10, in which at least one of the first and second power integration systems is operatively connected between each of a plurality of auxiliary power sources and the load.

15. A power supply system as recited in claim 1, in which:
at least one of the plurality of auxiliary power sources is a direct current power source that generates a DC power signal; and
the power integration system comprises an inverter for converting the DC power signal from the direct current power source to an AC power signal.

16. A power supply system as recited in claim 15, in which the first and second power integration systems each further comprises:
a DC bus;
an AC bus operatively connected to the load; and
a DC/DC converter connected between the direct current power source and the DC bus; wherein
the inverter is operatively connected between the DC bus and the AC bus.

17. A power supply system as recited in claim 5, in which at least one of the plurality of auxiliary power sources is an alternating current power source, where the alternating current power source is operatively connected to the AC bus of at least one of the first and second power integration systems.

18. A method of supplying power to a load from a grid power source and a plurality of auxiliary power sources, comprising the steps of:
providing a plurality of power control systems each comprising
a power integration system operatively connected between at least one of the plurality of auxiliary power sources and the load,
a power management board configured to selectively connect the grid power source to the power integration system,
a device controller operatively connected to the power integration system and to the power management board, and
a communications sub-system configured to carry data to the power management board and the device controller;
identifying one of the power control systems as a master power control system;
causing the master power control system to transmit a first set of data to the power management boards; and
causing the master power control system to transmit a second set of data to the power integration systems.

19. A method as recited in claim 18, in which:
the first set of data is time critical; and
the second set of data is non time critical.

20. A method as recited in claim 18, in which each of the device controllers comprises:
a relay controller that operates at least in part on the first set of data; and
a local controller that operates at least in part on the second set of data.
